(19) United States
(12) Patent Application Publication
(10) Pub. No.: US 2007/0011048 A1
(43) Pub. Date: Jan. 11, 2007

(54) Information providing system and information providing method

(75) Inventor: Hirohisa Naito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/251,755

(22) Filed: Oct. 18, 2005

(30) Foreign Application Priority Data
Jul. 11, 2005 (JP) 2005-202050

(51) Int. Cl. G06Q 30/00

(52) U.S. Cl. 705/14

(57) ABSTRACT

A reading unit reads personal identification information for identifying a user from a medium carried by the user. A providing unit provides display information through a large-screen display device based on the personal identification information. A recording unit records an association between the display information and the personal identification information. A detecting unit detects a purchase activity of the user corresponding to the personal identification information. An associating unit associates the advertisement provided to the user with the purchase activity, based on the personal identification information.

### BACKGROUND OF THE INVENTION

1. Field of the Invention

The present invention relates to a technology for providing information including advertisements, via a large-screen display device.

2. Description of the Related Art

In general, facilities with a large number of stores located therein, such as airports, department stores, and restaurant malls, have direction boards installed on their premises to display a list of the stores. It is common that advertisement fees collected from the stores listed on the direction boards are determined uniformly based on a size of the advertisement space and the like, without considering whether consumers actually view the direction boards prior to entering a store.

Furthermore, in many facilities such as convenience stores and train stations, a so-called kiosk terminal is installed to provide information to a user by operating the terminals. In regards to advertisement fees for advertisements displayed on such kiosk terminals, fee collection is sometimes conducted according to the actual number of times of displaying a screen on which an advertisement appears. Similarly, Internet web services commonly bill a client according to the number of times of displaying a screen with an advertisement appearing, or according to the number of times of clicking a banner advertisement.

However, it is not reflected on the above billing processes whether a user who views the advertisement actually purchases the merchandise being advertised. Consequently, a wide variety of measures are being conducted in an attempt to collect advertisement fees on which the purchase activity of users is reflected.

For example, Japanese Patent Application Laid-Open No. 2002-73886 discloses a conventional technology for verifying an advertising effect.

However, with the conventional technology, it is not possible to precisely calculate the advertising effect in the stores. Since the information on a user's viewing an advertisement is recorded on an IC card that is carried by the user, it is possible to acquire information that the user viewed an advertisement if the user uses the IC card to purchase merchandise. However, it is not possible to FIG. out the number of users who did not purchase merchandise in spite of viewing the advertisement. Consequently, the conventional technology can only make an approximate calculation of the advertising effect, such as the percentage of purchasers who viewed the advertisement included within the total number of users who purchased the merchandise.

Furthermore, even though the conventional technology is capable of figuring out the number of users who actually purchased merchandise in a store, it is not possible to acquire the number of users who did not purchase merchandise in spite of viewing the advertisement and entering the store or the number of users who did not purchase the merchandise while literally picking it up.

In addition, considering a billing for the store advertisements, it is insufficient if only the advertising effect on specific merchandise is calculated. This is because when stores conduct store advertisements containing advertising regarding a specific product, an advertising effect can be presumed even when merchandise other than the specific merchandise in the advertisement has been purchased.

Taking these factors into account, it is very important how to realize an information providing system that can precisely calculate the advertising effect, by collecting and applying a wide range of information regarding the provision of advertisements as well as a purchase activity of a consumer.

### SUMMARY OF THE INVENTION

It is an object of the present invention to at least solve the problems in the conventional technology.

An information providing system according to one aspect of the present invention provides display information including an advertisement through a large-screen display device. The information providing system includes a reading unit that reads personal identification information for identifying the user from a medium carried by the user; a providing unit that provides the display information through the large-screen display device based on the personal identification information; a recording unit that records an association between the display information and the personal identification information; a detecting unit that detects a purchase activity of the user corresponding to the personal identification information; and an associating unit that associates the advertisement provided to the user by the providing unit with the purchase activity detected by the detecting unit, based on the personal identification information.

A method of providing display information including an advertisement through a large-screen display device, according to another aspect of the present invention, includes reading personal identification information for identifying a user from a medium carried by the user; providing the display information through the large-screen display device based on the personal identification information; recording an association between the display information and the personal identification information; detecting a purchase activity of the user corresponding to the personal identification information; and associating the advertisement provided to the user at the providing with the purchase activity detected at the detecting, based on the personal identification information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating an outline of an information providing method according to the present invention;

FIG. 2 is a block diagram of an information providing apparatus according to the present invention;

FIG. 3 is a table of an example of an advertisement providing rule;

FIG. 4 is a table of an example of an advertisement-information management DB;

FIG. 5 is a table of an example of a provided-advertisement management DB;

FIG. 6 is a table of an example of an activity management DB;

FIG. 7 is a table of an example of an advertising effect index;

FIG. 8 is a block diagram of an activity detecting device;

FIG. 9 is a table of examples of the activity detecting device;

FIG. 10 is a flowchart of a processing procedure for an advertisement providing process;

FIG. 11 is a flowchart of a processing procedure for an activity detecting process;

FIG. 12 is a flowchart of a processing procedure for an advertising-effect calculating process; and

FIG. 13 is a schematic for illustrating an example of a network structure.

### DETAILED DESCRIPTION OF THE PREFERRED EMBODIMENTS

Exemplary embodiments of the present invention will be described in detail below with reference to the accompanying drawings. Following is a description of a case in which the information providing method is applied to an information providing apparatus that provides information by utilizing a large-screen display device.

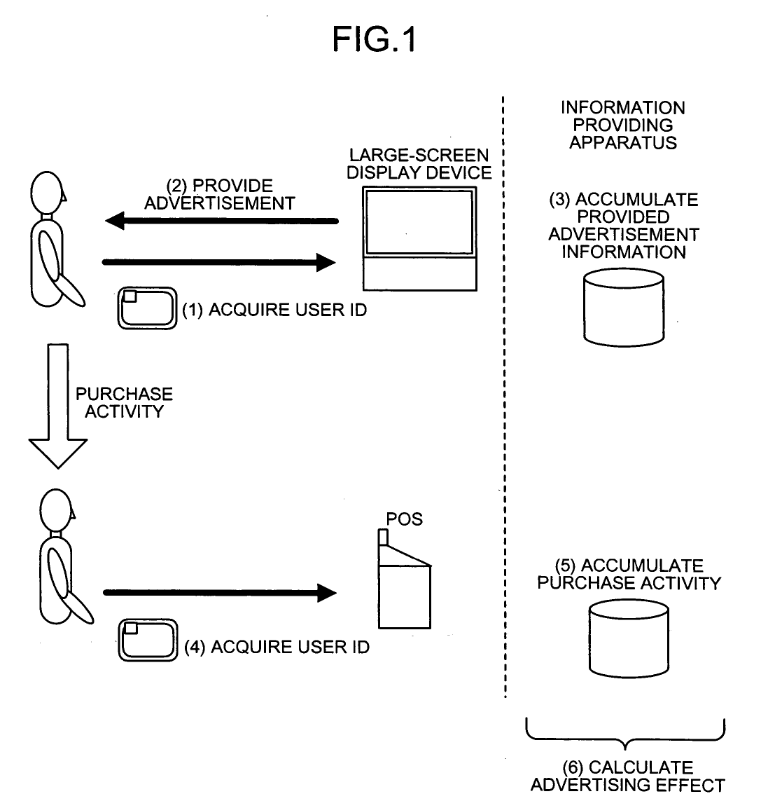

FIG. 1 is a schematic for illustrating an outline of an information providing method according to the present invention. The large-screen display device refers to an information display device including a card reader that reads information from contact-free ID cards, (for example, a radio frequency identification system (RFID) card), and a large-scale display that is visible to users from a distance (for example, a plasma display). Users are able to acquire desired information, such as store information, by holding up the ID card against the large-screen display device. The information providing method according to the present invention is to calculate the advertising effect of advertisements displayed together with such store information.

In the information providing method according to the present invention, when advertisements such as store advertisements are provided via a large-screen display device, the user ID of the user to whom the advertisement is directed is accumulated therein together with an advertisement history. When a purchase activity by the user is detected, the purchase activity will then be associated with the advertisement provided by utilizing an accumulated user ID, and the advertisement effect is calculated based on a predetermined advertising effect index.

When a user holds up an ID card against the large-screen display device, an information providing apparatus acquires the user ID via the large-screen display device. The apparatus provides an advertisement corresponding to the acquired user ID, such as a store advertisement, while accumulating information on the advertisement provided (hereinafter, “provided advertisement information”) including the IDs of the user and the provided advertisement in a storing unit.

The information providing apparatus detects the purchase activity of the user to whom the advertisement is provided. For example, as shown in FIG. 1, when the user purchases merchandise, the user ID is acquired by utilizing a point of sales (POS). Then, along with the acquired user ID, the apparatus accumulates the ID and quantity of the purchased merchandise, and classifies it as a purchase activity.

Since the “provided advertisement information” and “purchase activity” accumulated can be associated together by means of a user ID, the scope of advertising effect calculations can now include not only advertisements that result in a purchase activity, but also advertisements that do not. Therefore, a precise advertising effect calculation becomes possible.

Some conventional information providing methods have attempted to calculate the advertising effect by first storing advertisements regarding specific merchandise on an IC card of a user, and then utilizing the IC card and a POS system to detect a purchase of relevant merchandise. However, although such a procedure can evaluate advertisements that resulted in a purchase activity, it cannot evaluate advertisements that did not result in a purchase activity. For this reason, a precise advertising effect cannot be calculated.

Consequently, the information providing method according to the present invention accumulates user IDs when advertisements are provided, and also acquires user IDs when the user initiates a purchase activity. As a result, the provided advertisements can be associated with the purchase activity. In this manner, it becomes possible to evaluate advertisements that did not result in a purchase activity. Therefore, a multilateral analysis of advertising effect, such as calculating the ratio of the number of people who viewed the advertisement to the number of users who purchased the merchandise (purchasing ratio), can be conducted.

The information providing process according to the present invention increases the degree of accuracy of the advertising effect calculation, because it calculates advertising effect while utilizing an advertising effect index that describes a correlation between an advertisement and a purchase activity. The information providing process according to the present invention further improves the advertising effect calculation, because it detects a wide range of purchase activity. Consequently, collecting advertising fees that are commensurate with advertising effects becomes possible, by conducting a billing process based on advertising effects calculated.

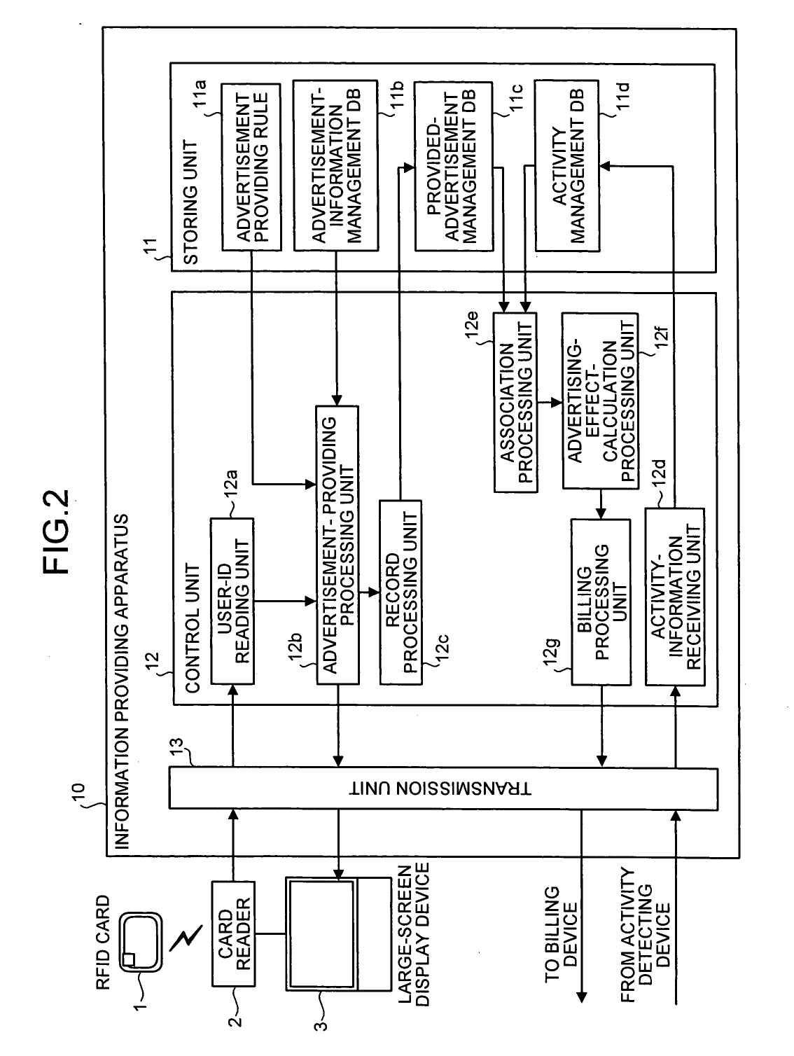

FIG. 2 is a block diagram of an information providing apparatus 10 according to an embodiment of the present invention. The information providing apparatus 10 is connected to a card reader 2 that reads information from an RFID card 1, a large-screen display device 3, a billing device, and an activity detecting device 20. According to the present embodiment, the billing device and the activity detecting device 20 are individual devices. However, the present invention is not limited to this configuration. It is also possible to include functions of the billing device and the activity detecting device 20 in the information providing apparatus 10.

The RFID card 1 is a card for storing information including a user ID for identifying a user. The RFID card 1 is capable of extracting information in a wireless (non-contact) environment. The RFID cards includes an RFID card using radio waves at 13.56 MHz band or 2.45 GHz band, an RFID card using a UHF band or any other frequency band, an active tag that self-transmits radio waves, and RFID cards using infrared, light, or ultrasound.

The card reader 2 is a device for reading the user ID from the RFID card 1. In addition, the card reader 2 may be structured as a device to be embedded in the large-screen display device 3. The large-screen display device 3 is a display device that complies with instructions from the information providing apparatus 10, and displays information desired by users, such as advertisements, by utilizing a hierarchical menu or the like. The large-screen display device 3 is also capable of displaying a plurality of windows on the on-screen display, to display information for a plurality of users simultaneously. In addition, it is highly expected that the large-screen display device 3 is installed in facilities such as train stations, airports, and shopping centers, and utilized instead of traditional signs, direction boards made of paper, and posters.

The information providing apparatus 10 includes a storing unit 11, a control unit 12, and a transmission unit 13. Furthermore, the storing unit includes an advertisement providing rule 11a, an advertisement-information management DB (database) 11b, a provided-advertisement management DB 11c, and an activity management DB 11d. The control unit 12 includes a user-ID reading unit 12a, an advertisement-providing processing unit 12b, a record processing unit 12c, an activity-information receiving unit 12d, an association processing unit 12e, an advertising-effect-calculation processing unit 12f, and a billing processing unit 12g.

The storing unit 11 is configured with a high-capacity storage device such as a disk-array apparatus, and stores the advertisement providing rule 11a, the advertisement-information management DB 11b, the provided-advertisement management DB 11c, and the activity management DB 11d. Although the information stored in the storing unit 11 is described independently, it is also possible to build a single information group by utilizing a relational database, etc.

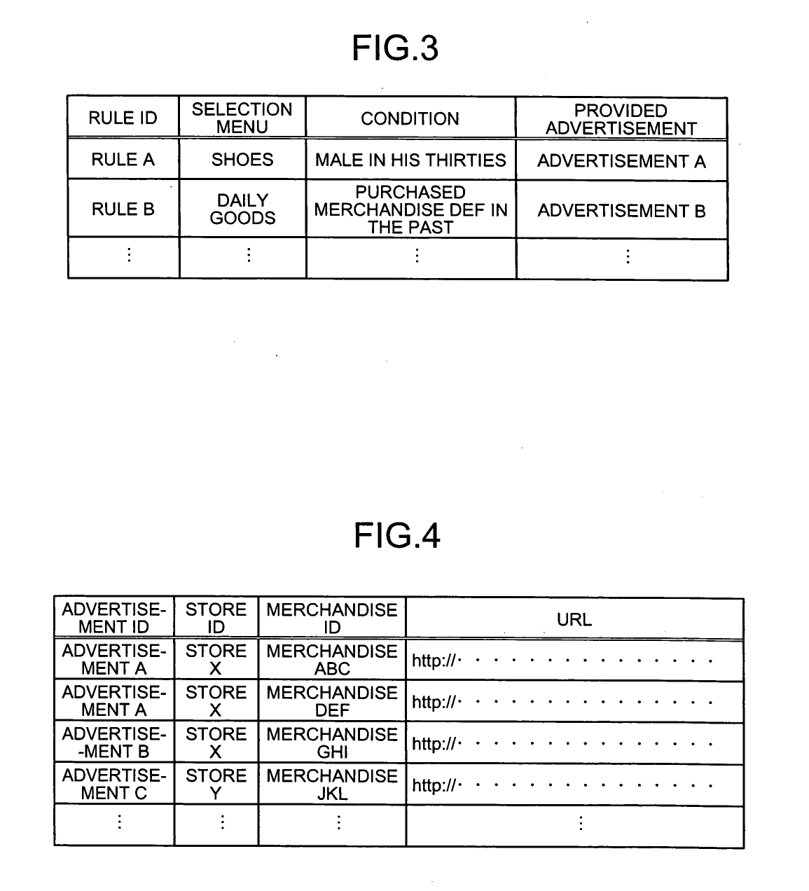

The advertisement providing rule 11a contains rules for providing advertisements that correspond to the user ID acquired from the RFID card 1. By utilizing the advertisement providing rule 11a, it becomes possible to provide advertisements on the large-screen display device 3 that correspond to the age and preferences of each of the users, even when a plurality of users select an identical menu on the large-screen display device 3. FIG. 3 is a table of an example of the advertisement providing rule 11a.

As shown in FIG. 3, the advertisement providing rule 11a includes a “rule ID” for identifying each rule, a “selection menu” describing a menu to which the rule is applied, a “condition” describing the contents of the rule, and a “provided advertisement” that is a description of the advertisement provided when the “condition” are satisfied. For example, when a user selects a menu related to “shoes” on the large-screen display device 3, if the user is over 35 years old, “advertisement A” is displayed on the large-screen display device 3. Furthermore, when a user selects a menu related to “daily goods”, and if the user has purchased “merchandise DEF” in the past, “advertisement B” is displayed on the large-screen display device 3. According to the present embodiment, advertisements corresponding to the user ID are provided utilizing the advertisement providing rule 11a. However, it is also possible to take a configuration in which the advertisement providing rule 11a is not utilized.

The advertisement-information management DB is a database for managing advertisement data provided from each store and advertising agency. In addition, the advertisement data can be either stored in the storing unit 11 via a transportable storage medium such as a CD-ROM and a DVD-RAM, or the data can be stored in the storing unit 11 via the transmission unit 13. Furthermore, it is also possible to store only linking information of an advertisement, which is stored in a server on a network, in the storing unit 11. FIG. 4 is a table of an example of the advertisement-information management DB 11b.

The advertisement-information management DB 11b includes an “advertisement ID” for identifying each advertisement, a “store ID” for identifying each store that is a sponsor, a “merchandise ID” for identifying each of merchandise included in the advertisement, and a “URL” describing a location in which the advertisement is stored. For example, “store X” is the sponsor of both “advertisement A,” including merchandise “ABC” and merchandise “DEF”, and “advertisement B,” including merchandise “GHI”. In addition, the URL can include a path to local disks and remote disks.

Advertisements managed by the advertisement-information management DB 11b include advertisements for a store itself, advertisements for merchandise handled by the store, and sales rankings of merchandise within the store. Furthermore, the advertisements can contain information such as campaign information and bargain information, such as “half price sale now on”, “limited time sale on between 12 PM to 1 PM”, and “20% off merchandise XX”.

The provided-advertisement management database 11c is a database in which the history of advertisements provided to users by the information providing apparatus 10 is accumulated, together with the user ID. The information providing apparatus 10 according to the present invention records which advertisement a user viewed (in other words, which advertisement was provided to the user), when providing a user with an advertisement. Therefore, it becomes possible to evaluate not only advertisements that led to a purchase activity, but also advertisements that did not lead to a purchase activity.

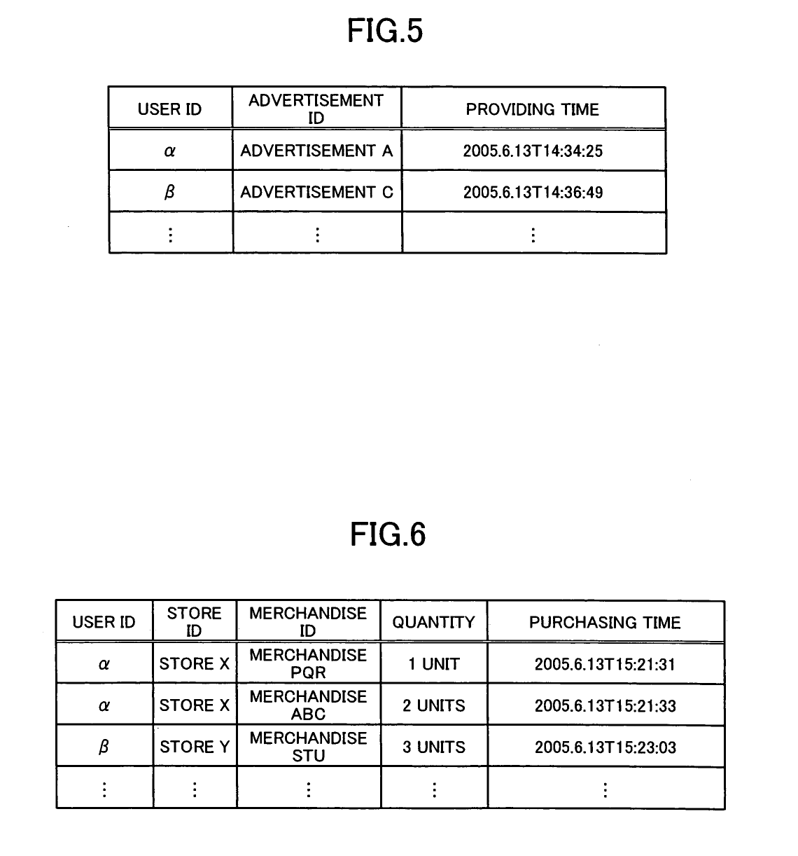

FIG. 5 is a table of an example of the provided-advertisement management DB 11c. The provided-advertisement management database 11c includes a “user ID” for identifying a user to whom an advertisement is provided, an “advertisement ID” for identifying the advertisement that is provided to the user, and a “providing time” describing the time the advertisement was provided. In addition, when a plurality of large-screen display devices 3 is used, it is also possible to include either a device ID for identifying each of the large-screen display devices 3, or positional information describing the installation location in the database.

For example, when “advertisement A” is provided to “a”, the provided-advertisement management database 11c registers “a” as the user ID, “advertisement A” as the advertisement ID, and “2005. 6. 13T14: 34: 25” as the providing time. Furthermore, when “advertisement C” is provided to “β”, the provided-advertisement management database 11c registers “β” as the user ID, advertisement C” as the advertisement ID, and “2005. 6. 13T14: 36: 49” as the providing time.

The activity management DB 11d is a database including a purchase activity of users acquired via the activity detecting device 20. FIG. 6 is a table of an example of the activity management DB 11d.

The activity management DB 11d is a database including a “user ID” for identifying a user who has conducted a purchase activity (in this case, a purchase of merchandise), a “store ID” for identifying each store that is a sponsor, a “merchandise ID” for identifying the merchandise purchased by the user, and a “purchasing time” describing the time the user purchased the merchandise.

For example, the activity management DB 11d has registered under each article thereon, “a” purchased at “store X” 1 unit of merchandise “PQR” and 2 units of merchandise “ABC”, together with the time of the purchase of each merchandise. Furthermore, the activity management DB 11d has registered under each article thereon, “β” purchased at “store Y” 3 units of merchandise “STU” together with the time of purchasing each of the merchandise.

The control unit 12 is a processing unit that displays advertisements on the large-screen display device 3 that correspond to the user ID received via the card reader 2, registers the history of provided advertisements and user IDs on the provided-advertisement management DB 11c in the storing unit 11, and registers purchase activity acquired via the activity detecting device 20 in the activity management DB 11d of the storing unit 11. In addition, the control unit 12 associates the information registered in the provided-advertisement management DB 11c and the activity management DB 11d by utilizing user ID, and calculates advertising effect by utilizing the advertising effect index.

The user-ID reading unit 12a is a processing unit that conducts the process of receiving user ID acquired by the card reader 2 via the transmission unit 13, and delivering the received user ID to the advertisement-providing processing unit 12b. In addition, if the user-ID reading unit 12a receives information on the user but is other than the user ID (for example, age, sex, etc.) from the card reader 2, the information is also delivered to the advertisement-providing processing unit 12b.

The advertisement-providing processing unit 12b is a processing unit that conducts the process of transmitting advertisements that are corresponding to user IDs to the large-screen display device 3. The user ID of the advertisement-providing processing unit is based on those received from the advertisement providing rule 11a, the advertisement-information management DB 11b, and the user-ID reading unit 12a. Furthermore, when a user operates the menu of the large-screen display device 3, the advertisement-providing processing unit 12b transmits an advertisement to the large-screen display device 3, which corresponds to the menu operation. Also, the advertisement-providing processing unit 12b delivers the history of advertisements provided to the users and the user IDs to the record processing unit 12c.

The record processing unit 12c is a processing unit that conducts the process of recording (registering) information received from the advertisement-providing processing unit 12b related to the provided advertisements, in the provided-advertisement management DB 11c of the storing unit 11. The record processing unit 12c can be structured to register the received information every time the processing unit receives information from the advertisement-providing processing unit 12b. The processing unit can also be structured to register the provided information regarding a specific user ID in a lump sum.

The activity-information receiving unit 12d is a processing unit that conducts the processes of receiving information via the transmission unit 13 related to purchase activity detected by the activity detecting device 20, and registering the received information in the activity management DB 11d of the storing unit 11.

The association processing unit 12e is a processing unit that conducts the process of associating information registered on the provided-advertisement management DB 11c and the activity management DB 11d which are both included in the storing unit 11, by means of the user ID. For example, the association processing unit 12e extracts the record related to “a” shown in FIG. 5, and then extracts the record related to “a” shown in FIG. 6. After the processing unit groups together the extracted information, the association processing unit 12e delivers the information to the advertising-effect-calculation processing unit 12f. The association processing unit 12e repeats such association by means of user ID with regard to every user IDs.

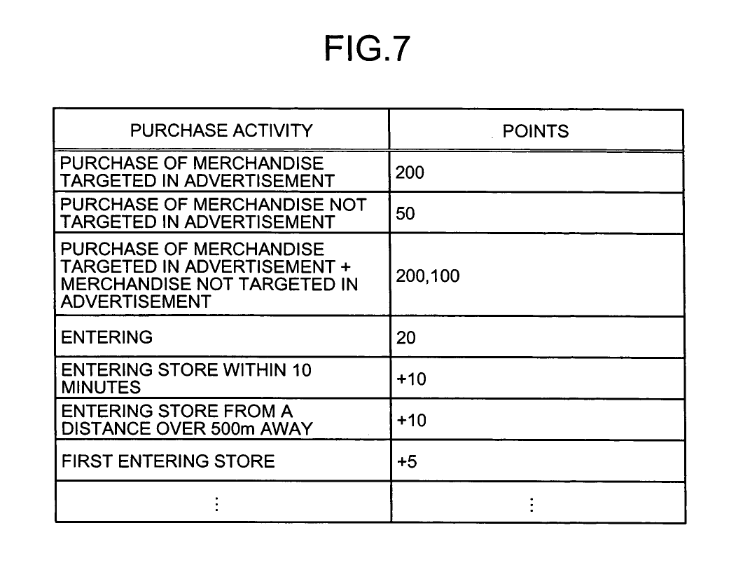

The advertising-effect-calculation processing unit 12f is a processing unit that conducts the process of calculating advertising effect. This is done by utilizing both the advertising effect index that indicates the correlation between the advertisement and the purchase activity and the purchase activity information and advertising providing information associated together by the association processing unit 12e. FIG. 7 is a table of an example of the advertising effect index.

The advertising effect index converts the correlation between the purchase activity initiated by users after viewing an advertisement and the advertisement that was provided into a numerical “points”. As shown in FIG. 7, the higher the points are, the higher the advertising effect is evaluated. For example, when a user purchases merchandise included within the advertisement after viewing an advertisement, the advertising effect is evaluated as 200 points. Furthermore, even when a user purchases merchandise that is not included in the advertisement after viewing the advertisement, advertising effect is evaluated as 50 points. Points are calculated even when users purchase merchandise not included in the advertisement, for advertising effect is evaluated to have occurred to a certain degree. This is so, for it is presumed that users entered the store seeking for the featured merchandise that appears in the advertisement, but chose to purchase different merchandise instead.

Furthermore, when merchandise targeted in advertisements and merchandise not targeted in advertisements are both purchased, the featured merchandise is considered to have provoked sufficient advertising effect, and therefore even higher points are calculated. The advertising effect index can also contain indexes for criteria other than the purchase of merchandise, such as when people are merely entering the store, the time elapsed from when a user views an advertisement to when the user enters the store or purchases merchandise, the distance between the location where the advertisement was viewed and the store where the merchandise was purchased, and the number of stores users entered after viewing the advertisement before entering the store. By calculating the advertising effect from a multilateral perspective in this way, it becomes possible to calculate the advertising effect precisely.

The billing processing unit 12g receives calculation results converted in to points from the advertisement-effect-calculation processing unit 12f. The billing processing unit then conducts the process of determining advertisement fees relating to each sponsor, by summing up the received calculation results per store. After determining the advertisement fees, the billing processing unit 12g transmits the information to a billing device on the network via the transmission unit 13. In addition, whereas the present embodiment describes the information providing apparatus 10 including the billing processing unit 12g, it is also possible to eliminate the billing processing unit 12g from the embodiment. In this case, output from the advertising-effect-calculation processing unit 12f could be transmitted to the billing device, or, the information providing apparatus 10 could be structured to include functions of the billing device instead.

The transmission unit 13 is structured from transmission devices such as a local-area-network (LAN) board, and is a device for conducting data transmission and reception with various devices set up on the network, such as the large-screen display device 3 and the activity detecting device 20. It is also possible to construct a wireless network to act as the transmission unit 13, by utilizing a wireless LAN board and such.

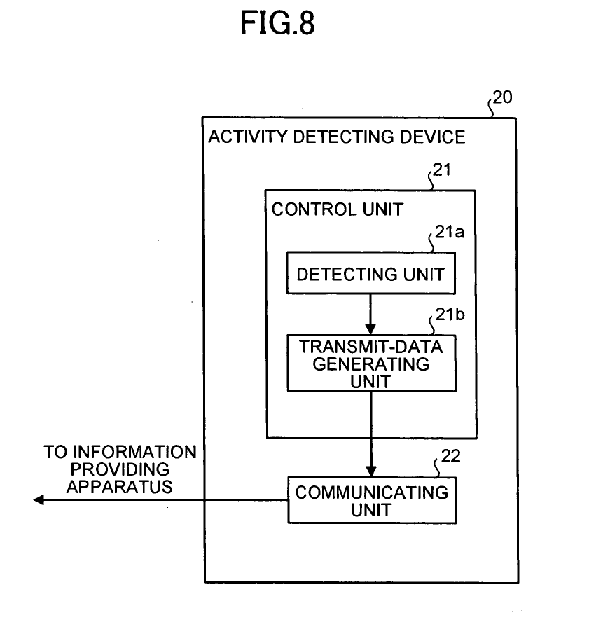

FIG. 8 is a block diagram of the activity detecting device 20. The activity detecting device 20 includes a control unit 21 and a communicating unit 22. The control unit 21 includes a detecting unit 21a and a transmit-data generating unit 21b.

The control unit 21 is a processing unit that conducts the process of detecting purchase activity of users who viewed an advertisement, by utilizing output from sensors and devices for acquiring user activity. At the same time, the control unit 21 also conducts the process of converting such detected information into a predetermined format, and transmitting them to the information providing apparatus 10.

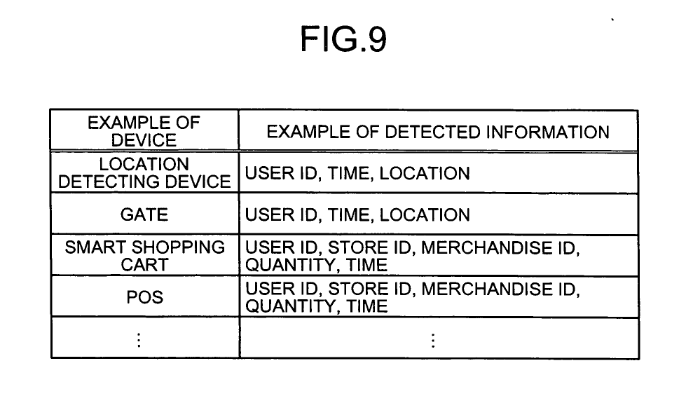

The detecting unit 21a is a processing unit that conducts the process of detecting purchase activity of users who viewed an advertisement, by utilizing output from sensors and devices for acquiring user activity. FIG. 9 is a table of examples of the activity detecting device 20.

When a position detecting device is utilized to act as the activity detecting device 20, information such as the user ID of the user, time of detection, and the location of the detection will be acquired. In addition, by setting up a plurality of units of position detecting devices alongside walkways of malls or other hallways, it becomes possible to monitor what sort of route a user will take after viewing an advertisement.

The “gate,” shown in FIG. 9, refers to a device set up at entrances of stores that reads the RFID card 1 of users as they pass through. Furthermore, the “smart shopping cart” is a so-called shopping cart attached with a reader device for reading RFID cards or RFID tags. By detecting purchase activity using the smart shopping cart, it becomes possible to recognize merchandise that are not purchased but were placed in the cart at least once.

The transmit-data generating unit 21b receives information from the detecting unit 21a, converts the received information into a predetermined format, and transmits the information to the information providing apparatus 10 via the communicating unit 22. The communicating unit 22 is structured from transmission devices such as the LAN board in the same way as the transmission unit 13 of the information providing apparatus 10.

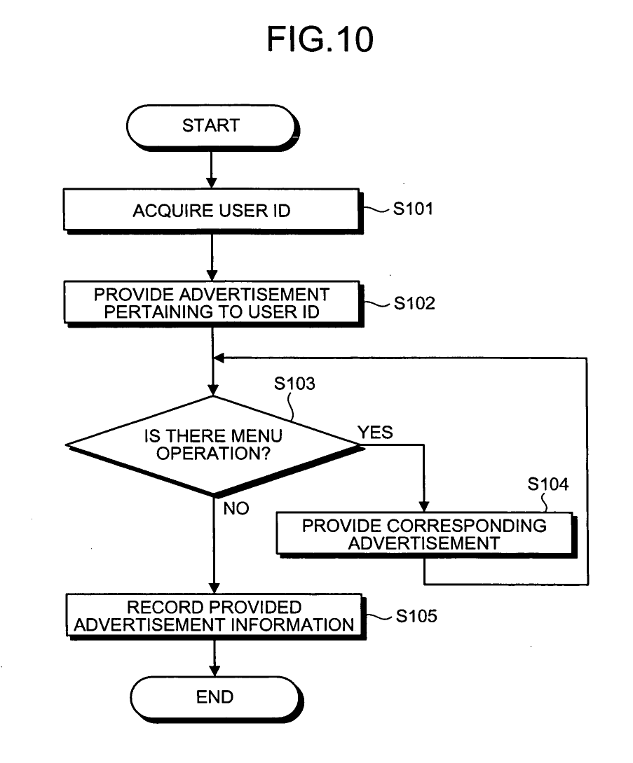

FIG. 10 is a flowchart of a processing procedure for an advertisement providing process. When the user-ID reading unit 12a acquires a user ID (step S101), the advertisement-providing processing unit 12b will provide the user with an advertisement related to such user ID, via the large-screen display device 3 (step S102). Following this, the advertisement-providing processing unit 12b will monitor whether or not the menu of the large-screen display device 3 will be manipulated by the user (step S103), and when the menu is manipulated, (step 103, Yes) the unit will provide the user with a relevant advertisement (step 104), and continue to repeat the process starting from step 103.

On the other hand, when the menu is not manipulated by the user (step 103, No), the provided advertisement information will be recorded (registered) on the provided-advertisement management DB 11c in the storing unit 11 via the record processing unit 12c, and all processes are then completed.

In regards to the description of step S102, although the step is described when advertisements related to the user ID are being provided, the description should not be limited to this structure, and advertisements unrelated to the user ID of the user can also be provided. In this case, when purchase activity initiated by the user who viewed the provided advertisement is detected, the user ID of the user to whom the advertisement was provided will be associated with the advertisement provided.

Furthermore, it is also possible to have a plurality of card readers 2 connected to the information providing apparatus 10, and structured so each card reader 2 has the menu allotted therein. By doing this, when a user manipulates the menu that is allot to the card reader 2 reading the user ID, the information providing apparatus 10 will be able to acquire the user ID and selected menu simultaneously.

For example, when 10 card readers A to J are connected, it becomes possible to allot menus to each card reader in various manners. For example, a menu for restaurants can be allot to card reader A, while a menu for clothing stores can be allot to card reader B, and a menu related to event information can be allot to card readers I through to J.

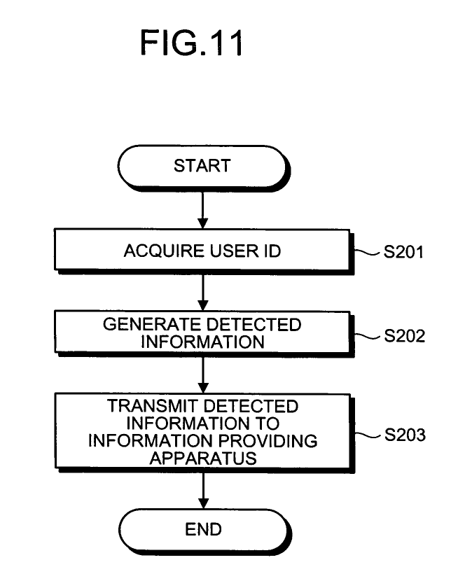

FIG. 11 is a flowchart of a processing procedure for an activity detecting process. The detecting unit 21a of the activity detecting device 20 will first acquire information (step S201) containing user ID (see FIG. 9). Following this, the transmit-data generating unit 21b will generate detected information that complies with a predetermined transmit format (step S202). Finally, the detected information converted into the transmit format is transmitted to the information providing apparatus 10 via the communicating unit 22, (step S203), and all processes are then completed.

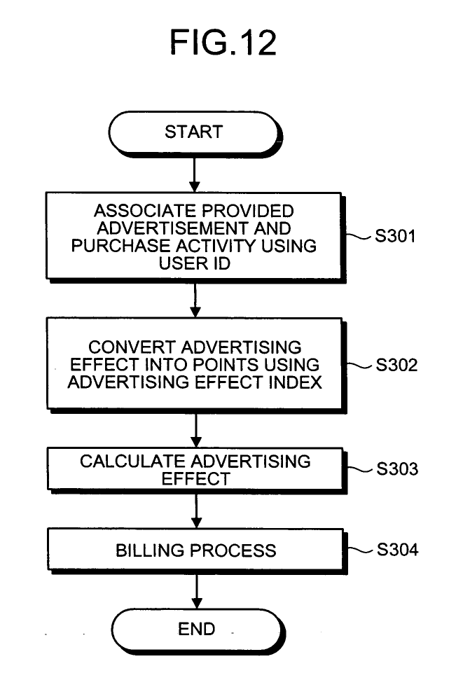

FIG. 12 is a flowchart of a processing procedure for an advertising-effect calculating process. The association processing unit 12e first associates provided advertisements with purchase activity, by utilizing the user ID (step S301). Following this, the advertising-effect-calculation processing unit 12f, will convert advertising effect into points by utilizing the advertising effect index (step S302), and calculate the advertising effect (step S303). Finally, the billing processing unit 12g then executes billing processing that is based on the calculated advertising effect against stores, etc., (step S304), and all processes are then complete.

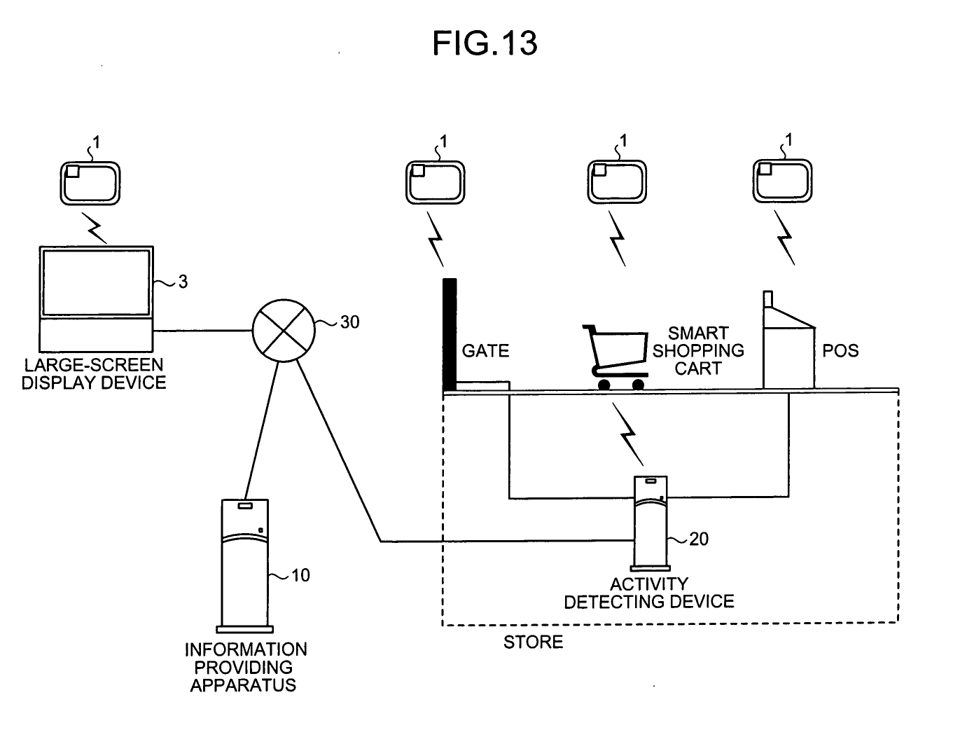

FIG. 13 is a schematic for illustrating an example of a network structure. The large-screen display device 3, the information providing apparatus 10, and the activity detecting device 20 are all connected with each other via a network 30. In addition, although it is shown that there is to be one unit of each device, it is also possible for the large-screen display device 3 to have multiple units, or the activity detecting device 20 to have multiple units.

Although, as shown in FIG. 13, a purchase activity is detected by installing a unit of the activity detecting device 20 that will communicate with devices such as gates, smart shopping carts, and POS terminals within a store, it is also possible to have one of the activity detecting device 20 installed per gate, or to install the activity detecting device 20 that is in charge of a plurality of stores. In addition, it is also possible to install numerous units of the activity detecting device 20 consisting of a position detecting device, along walkways, or other hallways.

If a user carrying the RFID card 1 views the advertisement displayed on the large-screen display device 3, information related to such advertisement and the user ID that is readout from the RFID card 1 is recorded in the information providing apparatus 10. If the user then initiates a purchase activity, devices such as gates and smart shopping carts will detect the purchase activity by the user, by means of acquiring information containing user ID from the RFID card 1. The activity detecting device 20, then collects the detected purchase activity, and transmits the information to the information providing apparatus 10 via network (30).

As described above, according to the present embodiment, the apparatus is structured in a manner wherein a user-ID reading unit first acquires user ID from a RFID card carried by users attempting to access the advertisements. The advertisement-providing processing unit is structured to then display information containing advertisements on the large-screen display device, while at the same time registering together with the user ID, a history of the advertisement that was provided, on the provided-advertisement management DB. Furthermore, the activity-information receiving unit is configured to register detected purchase activity on the activity management DB. After the association processing unit associates the provided advertisement with the purchase activity, the advertising-effect-calculation processing unit calculates advertising effect on the basis of the associated information and the advertising effect index. Therefore, by means of collecting a wide range of information relating to the provision of information regarding advertisements and purchase activity, a precise calculation of advertising effect can be achieved.

Meanwhile, the various processes described in the present embodiment can be realized by running pre-arranged programs on the respective computers. In such a case, a program corresponding to each processing unit shown in FIG. 2, for example, can be stored on a medium such as a ROM, and when the time comes to execute a process, a CPU can readout and run each program through the ROM. Thus, each program will be able to function as a process.

In addition, each program does not always have to be pre-recorded in ROM. For example, programs can be stored on “transportable physical mediums” that are readable by computers, such as flexible disks (FD), CD-ROMs, and magnet-optical disks. Programs can also be stored on “other computers (or servers)” connected to the computer via phone lines, internet, LAN, and WAN, and the system can be arranged so computers will readout and run programs from these sources.

According to the present invention, it is possible to make a precise calculation of an advertising effect.

Furthermore, according to the present invention, it is possible to improve the degree of accuracy in the calculation of the advertising effect.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system that provides display information including an advertisement through a large-screen display device, the information providing system comprising:
a reading unit that reads personal identification information for identifying a user from a medium carried by the user;
a providing unit that provides the display information through the large-screen display device based on the personal identification information;
a recording unit that records an association between the display information and the personal identification information;
a detecting unit that detects a purchase activity of the user corresponding to the personal identification information; and
an associating unit that associates the advertisement provided to the user by the providing unit with the purchase activity detected by the detecting unit, based on the personal identification information.

2. The information providing system according to claim 1, wherein
the purchase activity includes at least one of an entry into a predetermined area, an entry into a store, a placing of a merchandise in a shopping cart, and a purchase of a merchandise.

3. The information providing system according to claim 2, further comprising:
a calculating unit that calculates an advertising effect of the advertisement provided by the providing unit based on a result of association by the associating unit and an advertisement effect index that indicates a correlation between the advertisement and the purchase activity.

4. The information providing system according to claim 3, wherein
the calculating unit calculates the advertising effect, when the detecting unit detects the purchase of a merchandise, based on the advertising effect index that is set according to whether an advertisement of the merchandise is provided by the providing unit.

5. The information providing system according to claim 3, wherein
the calculating unit calculates the advertising effect based on a time from an output of the display information corresponding to the personal identification information to a detection of the purchase activity corresponding to the personal identification information.

6. The information providing system according to claim 3, wherein
the calculating unit calculates the advertising effect based on a distance from a place of outputting the display information corresponding to the personal identification information to a place of detecting the purchase activity corresponding to the personal identification information.

7. The information providing system according to claim 1, further comprising:
a billing unit that adjusts a billing to an advertisement-providing processing unit based on the advertising effect calculated by the calculating unit.

8. A method of providing display information including an advertisement through a large-screen display device, the method comprising:
reading personal identification information for identifying a user from a medium carried by the user;
providing the display information through the large-screen display device based on the personal identification information;
recording an association between the display information and the personal identification information;
detecting a purchase activity of the user corresponding to the personal identification information; and
associating the advertisement provided to the user at the providing with the purchase activity detected at the detecting, based on the personal identification information.

9. The method according to claim 8, wherein the purchase activity includes at least one of an entry into a predetermined area, an entry into a store, a placing of a merchandise in a shopping cart, and a purchase of a merchandise.

10. The method according to claim 9, further comprising:
calculating an advertising effect of the advertisement provided at the providing based on a result of association at the associating and an advertisement effect index that indicates a correlation between the advertisement and the purchase activity.

11. The method according to claim 10, wherein
the calculating includes calculating the advertising effect, when the purchase of a merchandise is detected at the detecting, based on the advertising effect index that is set according to whether an advertisement of the merchandise is provided at the providing.

12. The method according to claim 10, wherein
the calculating includes calculating the advertising effect based on a time from an output of the display information corresponding to the personal identification information to a detection of the purchase activity corresponding to the personal identification information.

13. The method according to claim 10, wherein
the calculating includes calculating the advertising effect based on a distance from a place of outputting the display information corresponding to the personal identification information to a place of detecting the purchase activity corresponding to the personal identification information.

14. The method according to claim 8, further comprising:
adjusting a billing to an advertisement-providing processing unit based on the advertising effect calculated by the calculating unit.
